(19) United States
(12) Patent Application Publication
(10) Pub. No.: US 2024/0222630 A1
(43) Pub. Date: Jul. 4, 2024

(54) SULFUR MATERIAL HAVING FUNCTIONALIZED SURFACE, PREPARATION METHOD THEREOF, ELECTRODE FOR METAL-SULFUR SECONDARY BATTERY INCLUDING THE SAME, AND METAL-SULFUR SECONDARY BATTERY INCLUDING THE SULFUR MATERIAL

(71) Applicant: RESEARCH & BUSINESS FOUNDATION SUNGKYUNKWAN UNIVERSITY, Suwon-si (KR)

(72) Inventors: Pil Jin YOO, Seoul (KR); Myeong Gyun NAM, Suwon-si (KR)

(73) Assignee: RESEARCH & BUSINESS FOUNDATION SUNGKYUNKWAN UNIVERSITY, Suwon-si (KR)

(21) Appl. No.: 18/393,519

(22) Filed: Dec. 21, 2023

(30) Foreign Application Priority Data
Dec. 21, 2022 (KR) 10-2022-0180099

(51) Int. Cl. H01M 4/60; H01M 4/02; H01M 10/052

(52) U.S. Cl. CPC H01M 4/60; H01M 10/052; H01M 2004/028

(57) ABSTRACT

Disclosed is asulfur material that can be used as an electrode material for a metal-sulfur secondary battery. The sulfur material includes a sulfur powder; and an organic molecular material chemically bonded to a surface of the sulfur powder, in which the organic molecular material includes first and second carbon atoms derived from a vinyl group and chemically bonded directly to sulfur atoms located both ends of the linear multiple sulfur material, respectively.

### CROSS REFERENCE TO RELATED APPLICATION

The present application claims priority to Korean Patent Application No. 10-2022-0180099, filed Dec. 21, 2022, the entire contents of which are incorporated herein for all purposes by this reference.

### BACKGROUND OF THE INVENTION

### Field of the Invention

The disclosure relates to a sulfur material having a surface functionalized with an organic molecular material, a preparation method thereof, an electrode for a metal-sulfur secondary battery including the same, and a metal-sulfur secondary battery including the sulfur material.

### Description of the Related Art

Sulfur is a crystalline material with a cyclic S8 molecule as a basic unit and is nonpolar. When the surface of a sulfur material is partially oxidized to introduce a functional group into sulfur, it is difficult to maintain a stable oxidized surface because sulfur is removed as a gas phase. Further, when the sulfur molecule (S8) is reduced, it is difficult to maintain a stable polarity on a particle surface because the sulfur molecule is converted into linear multiple sulfides causing elution due to its high solubility in polar solvents. Therefore, there have been no direct modification of sulfur particle surfaces and their applications. In particular, when the direction of the next-generation secondary battery process towards water-based processes is taken into account, it is essential to secure compatible lithium-sulfur battery materials and process technologies.

A lithium-sulfur battery system hasa high theoretical capacity, but exhibits poor electrochemical properties during a battery operation due to the low affinity of sulfur with lithium and electrolyte. While a commercial Li-ion battery electrode exhibits characteristics such as a surface capacity of more than 3 mAh/cm², a conductive material utilization rate of less than 3 wt %, and a full capacity realization rate at a current density of more than 1C, a Li-sulfur battery exhibits a capacity of less then 50% compared to that of the theoretical capacity.

To solve such problems of low rate and low utilization of sulfur, a composite method of injecting liquid sulfur into a porous host material and solidifying the injected sulfur has been proposed. However, the problem of practical difficulty in increasing the surface capacity due to decrease in the quantitative composition and tap tensity of sulfur in the electrode has not been solved, which limiting the commercialization of lithium-sulfur batteries.

### SUMMARY OF THE INVENTION

An aspect of the disclosure is to provide a sulfur material, of which the interior includes cyclic molecules of sulfur, such as cyclo-S8, having an orthorhombic crystal structure, and the surface includes a linear multiple sulfur material with about 2 to 7 sulfur atoms to form a closed ring-shaped chemical bond with first and second carbon atoms derived from a vinyl group of an organic molecular material, so that the surface can be functionalized by the organic molecule.

Another aspect of the disclosure is to provide a method of preparing the sulfur material.

Still another aspect of the disclosure is to provide an electrode for a metal-sulfur secondary battery, to which the sulfur material is applied.

Still another aspect of the disclosure is to provide a metal-sulfur secondary battery, in which the sulfur material is used as an electrode material.

According to an embodiment of the disclosure, a sulfur material may include a sulfur powder; and an organic molecular material chemically bonded to a surface of the sulfur powder.

According to an embodiment, the interior of the sulfur powder may have a crystalline structure with cyclic molecules of sulfur, the surface of the sulfur powder may include linear multiple sulfur material with about 2 to 7 sulfur atoms, and the organic molecular material may be chemically bonded to the sulfur atoms located at an end of the linear multiple sulfur material.

According to an embodiment, the organic molecular material may include first and second carbon atoms derived from a vinyl group and chemically bonded directly to the sulfur atoms located both ends of the linear multiple sulfur material, respectively. In this case, the first and second carbon atoms and the sulfur atoms of the linear multiple sulfur material form a chemical bond in a form of a closed ring.

According to an embodiment, the organic molecular material may include a polar functional group. For example, the polar functional group may include one or more selected from a group consisting of a hydroxyl group (—OH), a carboxyl group (—COOH), an amine group (—NH₂) and a sulfonic acid group (—SO₃H). According to an embodiment, the organic molecular material is derived from one or more selected from a group consisting of the following chemical formulae 1 to 13.

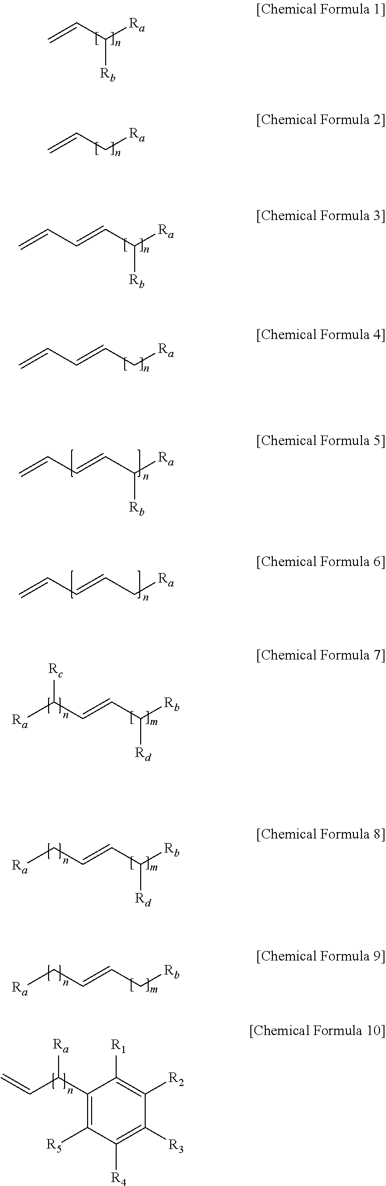

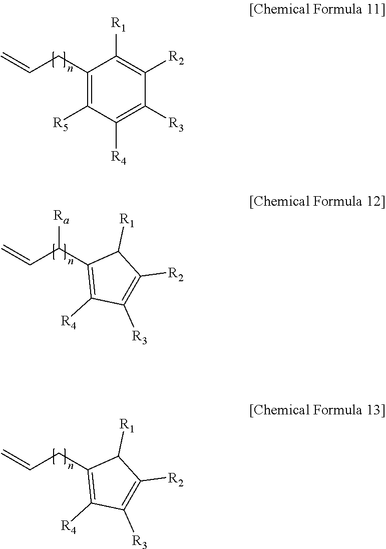

Here, Rₐ, R_{b}, R_{c}, R_{d}, R₁, R₂, R₃, R₄, R₅ and R₆ in each of the chemical formulae 1 to 13 are selected from a group consisting of hydrogen (H), a hydroxyl group (—OH), a carboxyl group (—COOH), an amine group (—NH₂), a sulfonic acid group (—SO₃H), and an aryl group (aryl) independently of each other, and n and m are integers of 0 to 100 independently of each other.

According to an embodiment of the disclosure, a method of preparing a sulfur material may include: first step of preparing a crystalline colloid of sulfur powder that contains cyclic molecules of sulfur; second step of forming first linear multiple sulfur ions by adding an alkali metal-containing basic solution to the colloid to ring-open the cyclic molecules of sulfur located on a surface of the sulfur powder; and third step of decomposing at least some of the first linear multiple sulfur ions into second linear multiple sulfur ions by adding an organic molecule having a vinyl group and an electron transfer-based oxidizing agent to the colloid, and forming a chemical bond by reacting the vinyl group of the organic molecule with the second linear multiple sulfur ions.

According to an embodiment, the alkali metal-containing basic solution may include a basic solution that contains lithium (Li) ions, sodium (Na) ions, or potassium (K) ions, and the cyclic molecules of sulfur located on the surface of the sulfur powder may be ring-opened to form linear multiple sulfur ions during the second step.

According to an embodiment, the alkali metal-containing basic solution may include a lithium hydroxide (LiOH) aqueous solution, a sodium hydroxide (NaOH) aqueous solution, or a potassium hydroxide (KOH) aqueous solution.

According to an embodiment, chemical bonds may be formed between sulfur atoms located at both ends of the second linear multiple sulfur ions and binding sites formed in first and second carbon atoms in the vinyl group activated by the electron transfer-based oxidizing agent during the third step.

According to an embodiment, the organic molecule may further include a polar functional group in addition to the vinyl group. For example, the polar functional group includes one or more selected from a group consisting of a hydroxyl group (—OH), a carboxyl group (—COOH), an amine group (—NH₂) and a sulfonic acid group (—SO₃H).

According to an embodiment, the organic molecule includes one or more selected from a group consisting of the following chemical formulae 1 to 13.

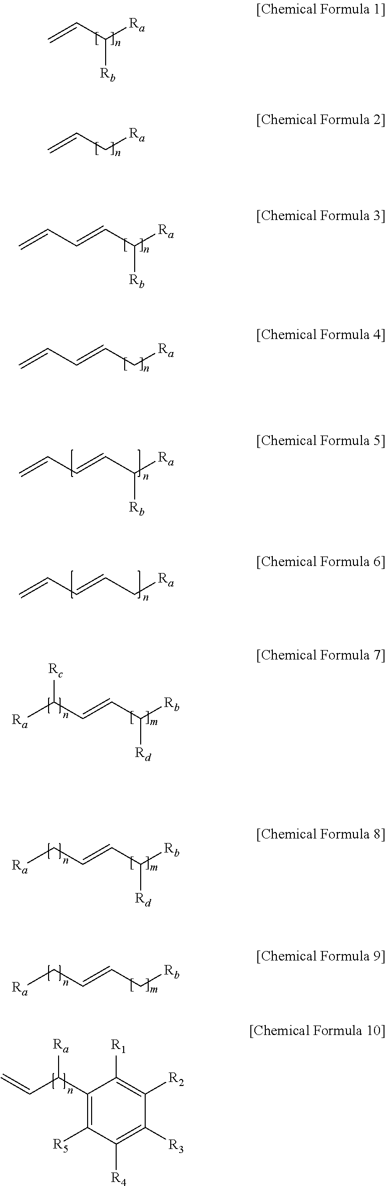

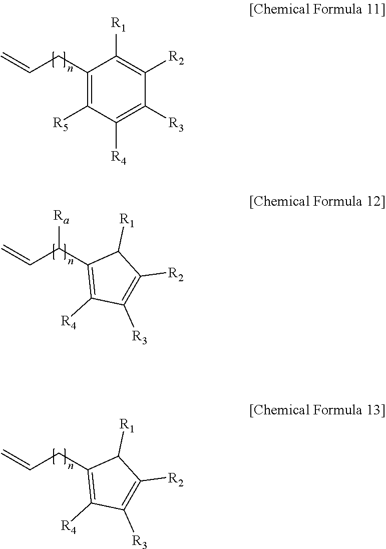

Here, Rₐ, R_{b}, R_{c}, R_{d}, R₁, R₂, R₃, R₄, R₅ and R₆ in each of the chemical formulae 1 to 13 are selected from a group consisting of hydrogen (H), a hydroxyl group (—OH), a carboxyl group (—COOH), an amine group (—NH₂), a sulfonic acid group (—SO₃H), and an aryl group (aryl) independently of each other, and n and m are integers of 0 to 100 independently of each other.

According to an embodiment, the organic molecule may be added to the colloid at a molar ratio of 10:1 to 1:10 relative to sulfur in the colloid.

According to an embodiment, the electron transfer-based oxidizing agent may include a persulfate compound, a permanganate compound, a perchlorate compound, or a perborate compound.

According to an embodiment, a hydrogen ion donating compound may further be added during the third step. For example, the hydrogen ion donating compound may include one or more inorganic acids selected from a group consisting of hydrochloric acid (HCL), sulfuric acid (H₂SO₄), nitric acid (HNO₃), and hydrogen peroxide (H₂O₂), or organic acid having a carboxyl group (—COOH), a hydroxyl group (—OH), or a sulfonic acid group (—SO₃H).

According to an embodiment of the disclosure, the electrode for the metal-sulfur secondary battery may include a sulfur material, a conductive material, and an active material layer including a binder, wherein the sulfur material includes the sulfur material described above.

According to an embodiment of the disclosure, a metal-sulfur secondary battery may include a positive electrode; a negative electrode disposed to face the positive electrode, and including lithium; and an electrolyte disposed between the positive electrode and the negative electrode, wherein the positive electrode includes the sulfur material described above.

### BRIEF DESCRIPTION OF THE DRAWINGS

FIG. 1 is a flowchart illustrating a method of preparing a sulfur material having a functionalized surface according to an embodiment of the disclosure.

FIG. 2 shows a scanning electron microscope (SEM) photographs of a bare sulfur powder and a sulfur powder prepared according to an embodiment.

FIGS. 3A and 3B show a photograph of an aqueous solution in which a sulfur powder prepared according to an embodiment is dispersed, and a graph showing zeta potential varied depending on pH of the sulfur powder prepared according to an embodiment, respectively.

FIGS. 4A and 4B show Raman spectroscopic analysis results and photoelectron spectroscopy (XPS) analysis results of a sulfur powder prepared as a present example 1, and FIG. 4C shows Raman spectroscopic analysis results of a sulfur powder prepared as a present example 2.

FIG. 5 shows XRD analysis results of a bare sulfur powder and a sulfur powder prepared according to an embodiment.

FIG. 6 shows NMR analysis results of the sulfur powder prepared as the present example 1.

FIG. 7 shows charge and discharge voltage profiles of half-cells to which an electrode of a comparative example and an electrode of the present example 1 are applied, respectively.

FIG. 8 shows cyclic voltammetry measurement results of the half-cell to which the electrode of the present example 1 is applied.

FIG. 9 shows charge and discharge cycle performance measurement results of the half-cell to which the electrode of the present example 1 is applied.

FIG. 10 shows shuttle current analysis results of the half-cell to which the electrode of the present example 1 is applied.

FIG. 11 shows electrochemical impedance measurement results of the half-cell to which the electrode of the present example 1 is applied.

### DETAILED DESCRIPTION OF THE INVENTION

Hereinafter, exemplary embodiments of the disclosure for solving the foregoing problems in practice will be described with reference to the accompanying drawings. In terms of describing the embodiments, the same terms and the same reference numerals may be used to describe the same configurations, and repetitive descriptions thereof will be avoided.

Below, the embodiments of the disclosure will be described in detail with reference to the accompanying drawings.

The disclosure may be modified variously and embodied in many alternative forms, and thus specific embodiments thereof will be shown by way of example in the accompanying drawings and described herein in detail. It should be understood, however, that the description is not intended to limit the disclosure to the specific embodiments, but is to cover all modifications, equivalents, and alternatives that fall within the spirit and scope of the disclosure. In the accompanying drawings, like numerals refer to like elements throughout.

For clarity, the dimensions of the structures in the accompanying drawings may be exaggerated compared to actual ones.

Terms such as “first” and “second” may be used to describe various elements, but the elements should not be limited by the above terms. In addition, the above terms are used only for the purpose of distinguishing one element from another. For example, a first element may be referred to as a second element, and the second element may also be referred to as the first element, without departing from the scope of the disclosure.

The terminology used herein is for the purpose of describing particular embodiments only and is not intended to limit the disclosure. Unless the context clearly dictates otherwise, singular forms include plural forms as well. In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

Unless otherwise defined, all the terms used herein, including technical and scientific terms, should be interpreted to have the same meanings as commonly understood by a person having ordinary knowledge in the art to which the disclosure pertains. The terms defined in commonly used dictionaries should be interpreted as having a meaning that is consistent with their meaning in the context of the related art, and should not be interpreted to have ideal or excessively formal meanings unless explicitly defined in the disclosure.

<Sulfur Powder with Functionalized Surface and Preparation Method Thereof>

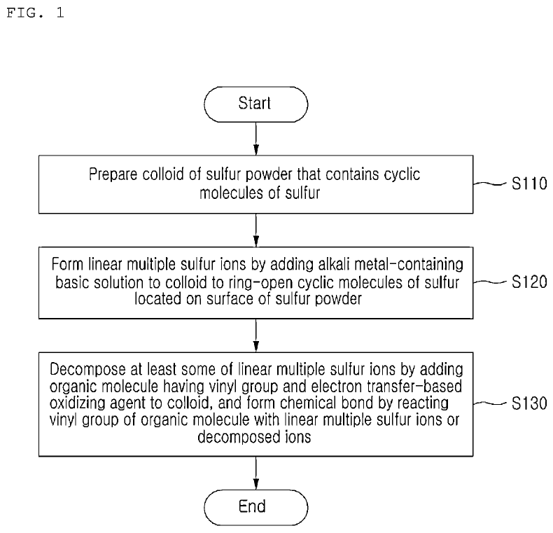

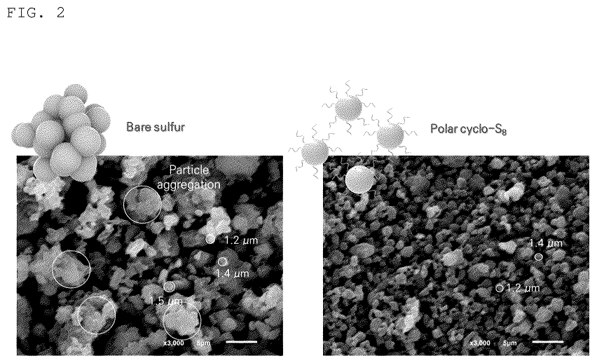

FIG. 1 is a flowchart illustrating a method of preparing a sulfur material having a functionalized surface according to an embodiment of the disclosure.

Referring to FIG. 1, a method of preparing a sulfur material having a functionalized surface according to an embodiment of the disclosure may include first step S110 of preparing a colloid of sulfur powder that contains cyclic molecules of sulfur; second step S120 of forming linear multiple sulfur ions by adding an alkali metal-containing basic solution to the colloid to ring-open cyclic molecules of sulfur located on a surface of the sulfur powder; and third step S130 of decomposing at least some of the linear multiple sulfur ions by adding an organic molecule having a vinyl group and an electron transfer-based oxidizing agent to the colloid, and forming a chemical bond by reacting the vinyl group of the organic molecule with the linear multiple sulfur ions or the decomposed ions.

In the first step S110, the sulfur powder is a crystalline inorganic material, which may include a cyclic molecule of sulfur, such as cyclo-S8, and its shape is not limited. According to an embodiment, the sulfur powder may have a spherical, polyhedral, amorphous, or the like shape, and may have a size of about 10 nm to 100 μm. Meanwhile, there are no particular limits to a solvent for the colloid, and thus various solvents may be used without limitation. For example, water may be used as the solvent for the colloid. According to an embodiment, the colloid may contain the sulfur powder at a concentration of about 1 to 1000 mg/ml.

In the second step S120, when the alkali metal-containing basic solution is added to the sulfur powder colloid, the cyclic molecules of sulfur located on the surface of the sulfur powder are exposed to ions of the alkalimetal, and thus the cyclic molecules of sulfur located on the surface are ring-opened by the following chemical equation 1, thereby forming the linear multiple sulfur ions. On the other hand, the cyclic molecules of sulfur located inside the sulfur powder are not exposed to the ions of the alkali metal, thereby not only maintaining a cyclic molecular structure but also maintaining a crystalline state.

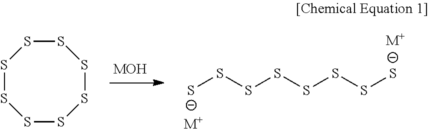

In the chemical equation 1, M represents an alkalimetal.

According to an embodiment, the alkalimetal-containing basic solution may include a basic solution that contains one or more selected from among lithium(Li) ions, sodium (Na) ions, potassium (K) ions, etc. For example, the alkalimetal-containing basic solution may include one or more selected from among a lithium hydroxide (LiOH) aqueous solution, a sodium hydroxide (NaOH) aqueous solution, a potassium hydroxide (KOH) aqueous solution, etc.

The alkalimetal-containing basic solution may contain the alkalimetal at a concentration of about 0.01 to 10M, and there are no particular limits to a mixing ratio of the colloid solution and the basic solution. For example, the colloid solution and the basic solution may be mixed at a volume ratio of about 1000:1 to 1:1000.

According to an embodiment, to ring-open the cyclic molecules of sulfur located on the surface of the sulfur powder, the basic solution may be added to the sulfur powder colloid and then agitated for about 10 minutes to 1 hour while being heated at a temperature of about 40 to 70° C.

In the third step S130, when the organic molecule having the vinyl group and the electron transfer-based oxidizing agent are added to the sulfur powder colloid, the surface of which is formed with the linear multiple sulfur ions, the vinyl group of the organic molecule may be activated by the electron transfer-based oxidizing agent, and thus the organic molecule may be chemically bonded to the end of the linear multiple sulfur located on the surface of the sulfur powder as shown in the following chemical equation 2. For example, in the case where the vinyl group is activated by the electron transfer-based oxidizing agent, a chemical bond may be directly formed between first carbon located at the end of the vinyl group and a sulfur atom located at a first end of the linear multiple sulfur. On the other hand, in the case where the vinyl group is activated by the electron transfer-based oxidizing agent, a binding site may be formed even in second carbon of the vinyl group to be bonded to the first carbon, and a chemical bond of the second carbon may also be directly formed between sulfur atoms located at a second end of the linear multiple sulfur opposite to the first end even though it is not shown in the following chemical equation 2. In this case, the first and second carbon atoms of the vinyl group are coupled to the sulfur atoms located at both ends of the linear sulfur, thereby forming acyclic structure.

According to an embodiment, when the organic molecule has a functional group capable of donating a hydrogen ion, for example, a carboxyl group, or when a compound capable of donating hydrogen ions is further added to the colloid, a first linear multiple sulfur ion consisting of eight sulfur atoms are decomposed to form a plurality of second linear multiple sulfur ions consisting of fewer than eight sulfur atoms, and chemical bonds are formed between the sulfur atoms located at both ends of the second linear multiple sulfur ions and the binding sites formed in the first and second carbon atoms of the activated vinyl group, respectively, so that the organic molecule can be bounded to the surface of the sulfur powder. In this case, the first and second carbon atoms of the vinyl group are respectively bonded to the sulfur atoms located at both ends of the second linear sulfur ions to form a cyclic structure, thereby significantly suppressing formation of soluble lithium-polysulfides during a lithiation reaction.

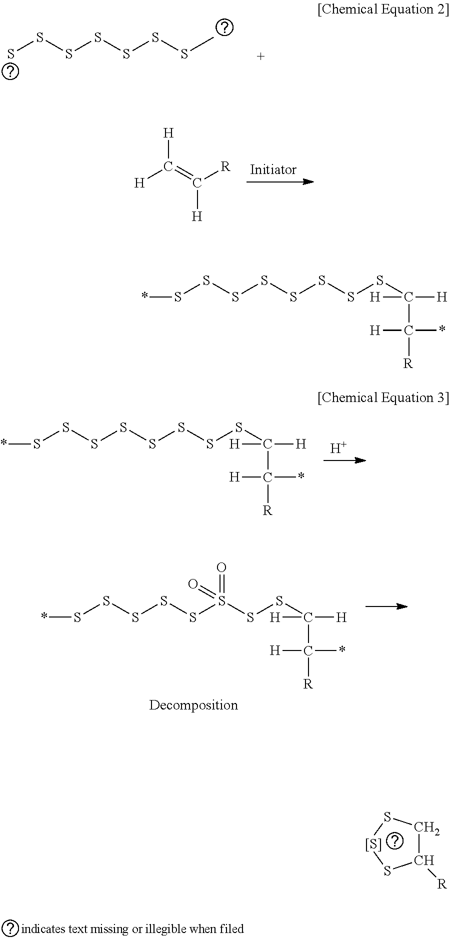

In the chemical equation 3, n may be an integer of 0 to 6.

According to an embodiment, the organic molecule is not particularly limited as long as it has the vinyl group capable of forming a chemical bond with each of the two sulfur atoms located at both ends of the linear sulfur compound.

According to an embodiment, the organic molecule may have a skeleton of linear or branched alkyl chains with about 2 to 100 carbon atoms, or a substituted or unsubstituted aryl skeleton with about 2 to 100 carbon atoms.

According to an embodiment, the organic molecule may further include a polar functional group in addition to the vinyl group so that the sulfur powder of which the surface is functionalized by the organic molecule can be well dispersed in a polar solvent such as water, or other types of metal can be chemically adsorbed to sulfur powder. For example, the organic molecule may include one or more polar functional groups selected from among hydroxyl groups (—OH), carboxyl groups (—COOH), amine groups (—NH₂), sulfonic acid groups (—SO₃H), etc.

According to an embodiment, the organic molecule may include one or more selected from a group consisting of the following chemical formulae 1 to 13.

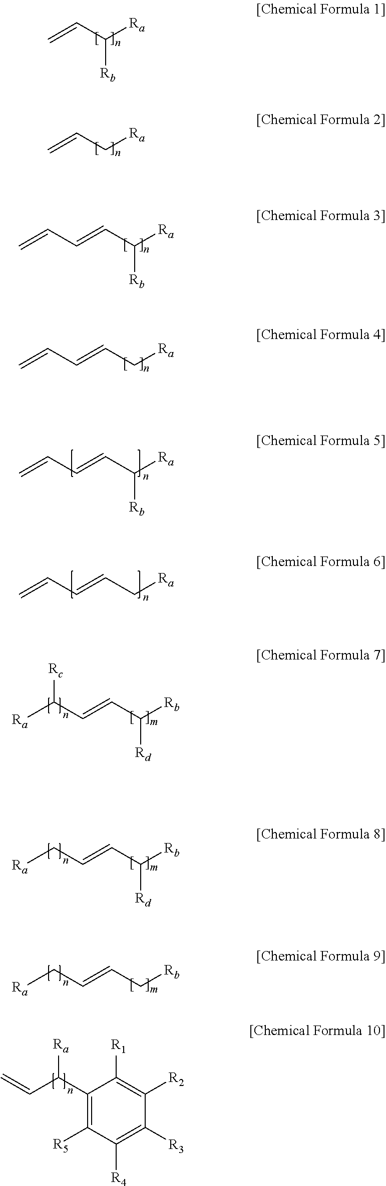

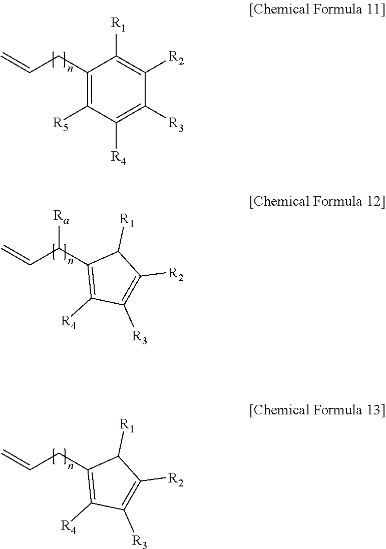

In the chemical formulae 1 to 13, Rₐ, R_{b}, R_{c}, R_{d}, R₁, R₂, R₃, R₄, R₅ and R₆ are selected from a group consisting of hydrogen (H), the hydroxyl group (—OH), the carboxyl group (—COOH), the amine group (—NH₂), the sulfonic acid group (—SO₃H), and the aryl group (aryl) independently of each other, and n and m are integers of 0 to 100 independently of each other.

According to an embodiment, the organic molecule may be added to the colloid at a molar ratio of about 10:1 to 1:10 relative to sulfur in the colloid.

According to an embodiment, the electron transfer-based oxidizing agent may include one or more selected from among a persulfate compound, a permanganate compound, a perchlorate compound, a perborate compound, etc. According to an embodiment, the electron transfer-based oxidizing agent may be added at a molar ratio of about 40:1 to 1:40 relative to sulfur in the colloid.

According to an embodiment, the hydrogen ion donating compound may include inorganic acid such as hydrochloric acid (HCl), sulfuric acid (H₂SO₄), nitric acid (HNO₃), and hydrogen peroxide (H₂O₂), or organic acid having the carboxyl group (—COOH), the hydroxyl group (—OH), the sulfonic acid group (—SO₃H), etc.

The sulfur material having the functionalized surface prepared by the foregoing method according to an embodiment of the disclosure may include the sulfur powder; and the organic molecular material chemically bonded to the surface of the sulfur powder.

The interior of the sulfur powder includes the cyclic molecules of sulfur, such as cyclo-S8, and has an orthorhombic crystal structure. In addition, the surface of the sulfur powder may include the linear multiple sulfur material with about 2 to 8, for example, about 2 to 7 sulfur atoms.

The organic molecular material may be chemically bonded to the sulfur atom located at the end of the linear multiple sulfur material.

According to an embodiment, the organic molecule may include the first and second carbon atoms derived from the vinyl group, which are chemically bonded directly to the sulfur atoms located at both ends of the linear multiple sulfur material by activation of the vinyl group, and the first carbon atom may be bonded to the second carbon atom by a chemical single bond. For example, the first and second carbon atoms and the sulfur atoms of the linear multiple sulfur material may form a chemical bond in the form of a closed ring.

According to an embodiment, the organic molecule may have a skeleton of linear or branched alkyl chains with about 2 to 100 carbon atoms, or a substituted or unsubstituted aryl skeleton with about 2 to 100 carbon atoms.

According to an embodiment, the organic molecular material may further include one or more polar functional groups selected from among hydroxyl groups (—OH), carboxyl groups (—COOH), amine groups (—NH₂), sulfonic acid groups (—SO₃H), etc. In addition to the vinyl group so that the sulfur powder with the organic molecular material bonded to the surface thereof can be well dispersed in a polar solvent such as water, or other types of metal can be chemically adsorbed to sulfur powder.

According to the method of preparing the sulfur material having the functionalized surface according to the disclosure and the sulfur material having the functionalized surface prepared by the same, the sulfur material includes the cyclic molecules of sulfur, such as cyclo-S8, in the interior thereof, and includes the linear multiple sulfur material located on the surface thereof with about 2 to 7 sulfur atoms, in which a chemical bond is formed in the form of a closed ring between the sulfur atoms and the first and second carbon atoms derived from the vinyl group of the organic molecular material, so that the surface of the sulfur material can be functionalized by the organic molecule, thereby significantly reducing the formation of soluble lithium-polysulfides when applied to a secondary battery.

In addition, the organic molecular material may include the polar functional group, thereby significantly improving the dispersibility of the sulfur powder in the polar solvent such as water.

### <Electrode for Metal-Sulfur Secondary Battery, Preparation Method Thereof, and Metal-Sulfur Secondary Battery>

The sulfur material having the functionalized surface according to the disclosure may be mixed with a conductive material and a binder, and used as a positive electrode active material for a metal-sulfur secondary battery.

According to an embodiment, slurry that contains the sulfur material having the functionalized surface according to the disclosure, the conductive material, and the binder is applied to a first metal current collector and dried to manufacture a positive electrode of the metal-sulfur secondary battery. In this case, there are no particular limits to the materials for the conductive material and the binder, and publicly known materials for the conductive material and the binder applied to the positive electrode active material of the metal-sulfur secondary battery may be used without limitation.

Meanwhile, the metal-sulfur secondary battery may include a negative electrode disposed to face the positive electrode, and an electrolyte disposed between the positive elect rode and the negative electrode, in which a metal electrode that contains lithium may be used as the negative electrode. There are no particular limits to the materials for the negative electrode and the electrolyte, and publicly known materials for the negative electrode and the electrolyte may be used without limitation.

Below, specific embodiments of the disclosure will be described. However, the following examples are merely some embodiments of the disclosure, and the scope of the disclosure is not limited to the following examples.

### Present Example 1

50 ml of NaOH aqueous solution with a concentration of 0.5 M was added to 0.7 g of sulfur powder colloid, and the mixed solution was agitated for 30 minutes while being heated at 85° C. Then, 1.48 g of persulfate was added as the electron transfer-based oxidizing agent to the agitated solution, and agitated for 5 minutes. Then, acrylic acid organic molecules were added at a molar ratio of 0.25 relative to sulfur to a solution added with an oxidizing agent, and agitated for 12 hours at room temperature.

The obtained solution was separated into a solid phase and a solution phase by centrifugation, and then metal salts and excess organic materials contained therein were removed using water and a polar organic solvent. Then, the obtained solid phase was dried at 70° C. to obtain surface-modified sulfur particles.

Then, the surface-modified sulfur particles were mixed with the conductive material at a mass ratio of 70:25 to manufacture the positive electrode.

### Present Example 2

surface-modified sulfur particles were obtained by the same method as the present example 1 except that 4-vinylbenzoic acid organic molecules were used instead of the acrylic acid organic molecules.

### Comparative Example

The positive electrode was manufactured by mixing bare sulfur particles having an unmodified surface with a conductive material at a mass ratio of 70:25.

### Experimental Example

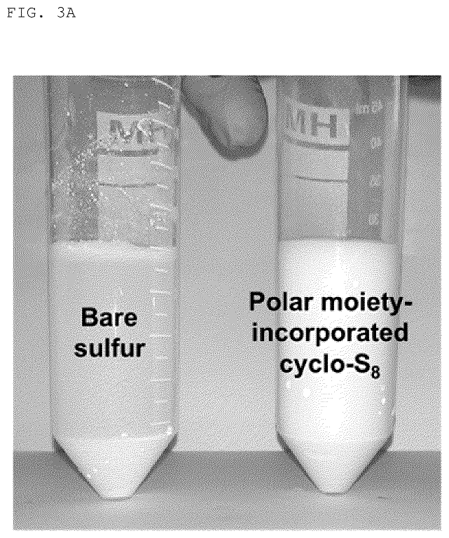

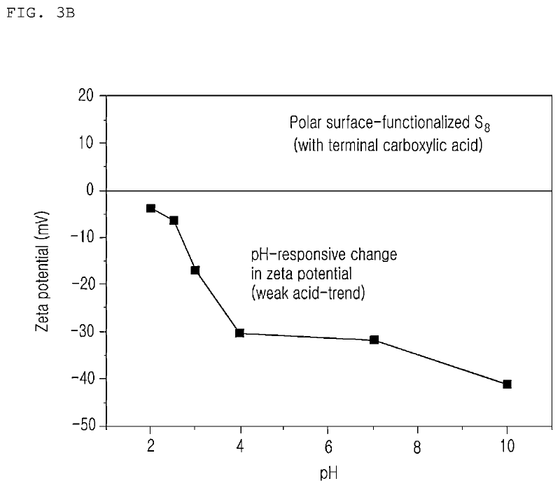

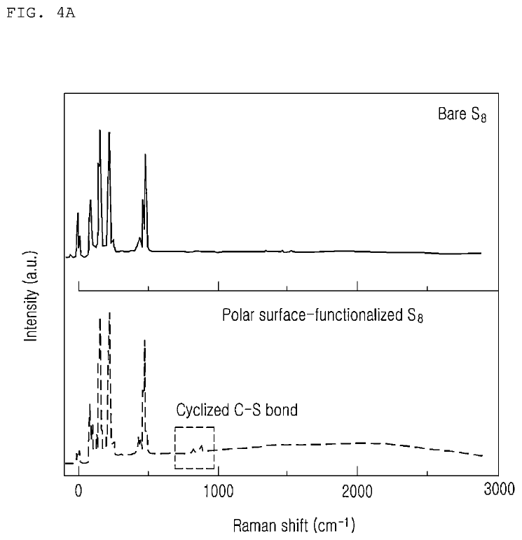

FIG. 2 shows a scanning electron microscope (SEM) photographs of a bare sulfur powder and the sulfur powder prepared according to the present example 1, and FIGS. 3A and 3B show a photograph of an aqueous solution in which the sulfur powder prepared according to the present example 1 is dispersed, and a graph showing zeta potential varied depending on pH of the sulfur powder prepared according to the present example 1, respectively.

Referring to FIGS. 2, 3A and 3B, while the bare sulfur exhibited very low water dispersibility even under strong ultrasonic dispersion conditions, the sulfur powder prepared according to the present example 1 exhibited excellent water dispersibility and a surface zeta-potential value of about −40 mV. Further, the sulfur powder prepared according to the present example 1 exhibited zeta-potential varied depending on pH of the solution, and it was found based on change in zeta-potential under acidic conditions that the carboxylic acid functional group was chemically bonded to the surface of the sulfur powder.

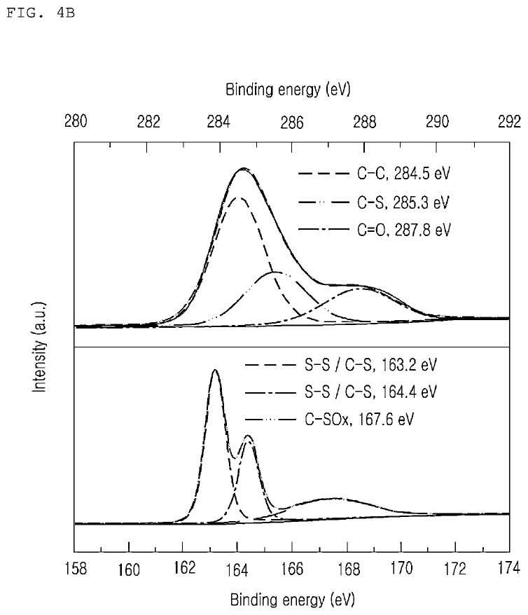

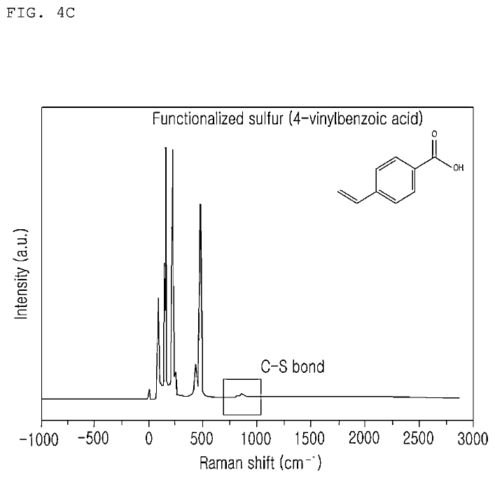

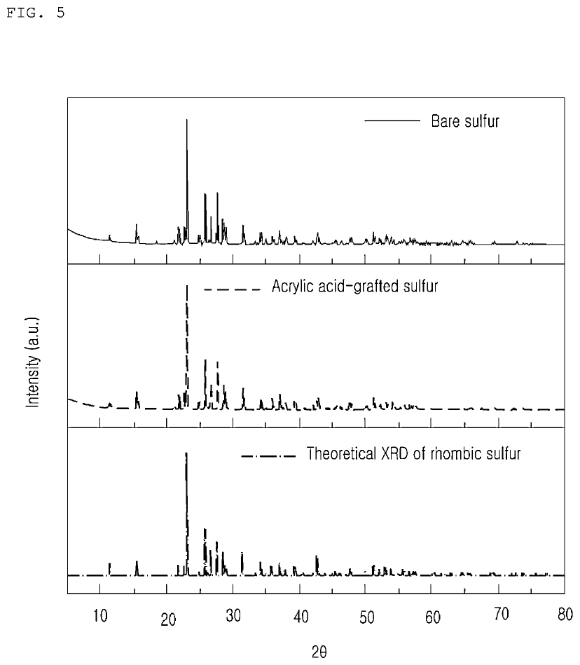

FIGS. 4A and 4B show Raman spectroscopic analysis results and photoelectron spectroscopy (XPS) analysis results of the sulfur powder prepared according to the present example 1, FIG. 4C shows Raman spectroscopic analysis results of the sulfur powder prepared according to the present example 2, and FIG. 5 shows XRD analysis results of a bare sulfur powder and a sulfur powder prepared according to the present example 1.

Referring to FIGS. 4A, 4B, 4c and 5, it was found through the Raman spectra that the sulfur powder prepared according to the present examples 1 and 2 exhibited both the polysulfur bond (S—S bond) present in polysulfide and the cyclized C—S bond absent in the bare sulfur. Specifically, in the case of the sulfur powder prepared according to the present examples, additional C—S bond-related peaks in the Raman shift band between 500 and 1000 cm-1 were observed simultaneously along with the S—S bond peaks in the Raman shift band below 500 cm-1 observed in the bare sulfur. Here, the additional C—S bond-related peaks demonstrate that carbons derived from the vinyl group of the organic material form a closed-ring together with the linear multiple sulfur.

From the XPS analysis results, in the case of the sulfur powder prepared according to the present example 1, obvious peaks for the presence of the organic functional groups were observed in the C 1s region, and the presence of C—S bonds in the S 2p region as well as in the C 1s region was found. Further, from the XRD analysis results, it was found that the sulfur powder prepared according to the present example 1 had the same rhombic structure as the bare sulfur. Thus, the sulfur powder prepared according to the present example 1 maintains the rhombic structure in the interior thereof, and includes the organic molecules chemically bonded to the linear multiple sulfur located on the surface thereof.

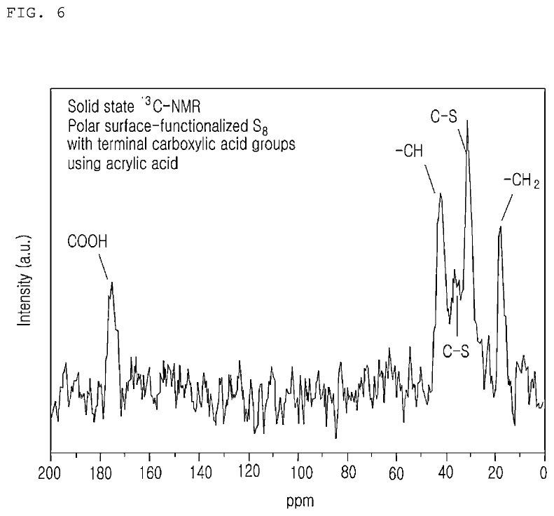

FIG. 6 shows 13C-NMR analysis results of the sulfur powder prepared as the present example 1.

Referring to FIG. 6, the sulfur powder prepared as the present example 1 includes the chemical bond of carbon atoms, which is not present in the bare sulfur. In detail, carbon atoms in the present example 1 have an organic structure including a carboxylic acid (—COOH, 170 to 180 ppm), a linear carbon bond structure (—CH₂—, 40 to 50 ppm) and two sulfide bonds (—CS—, 30 to 40 ppm). Thus, the acrylic acid used in the present example 1 is present on the particles as it is bonded to the surface of the sulfur. Further, the organic materials included in the present example 1 includes two types of sulfide bonds, and thus included on the surface of the particles in the form of cyclic molecules that contain sulfur.

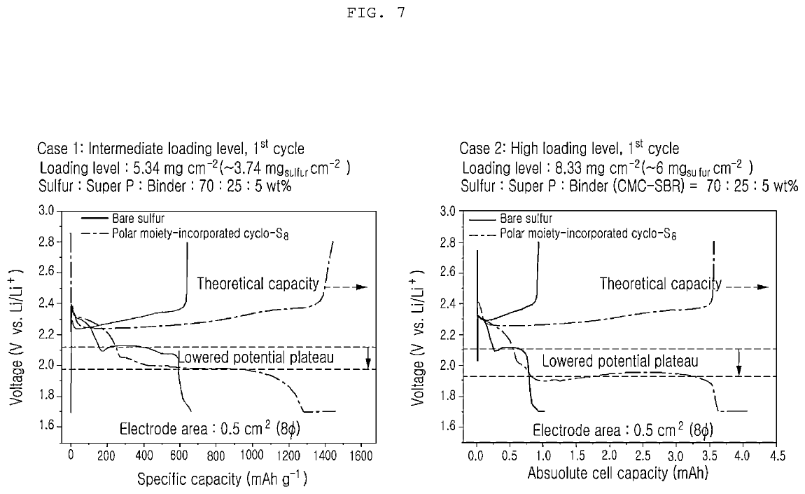

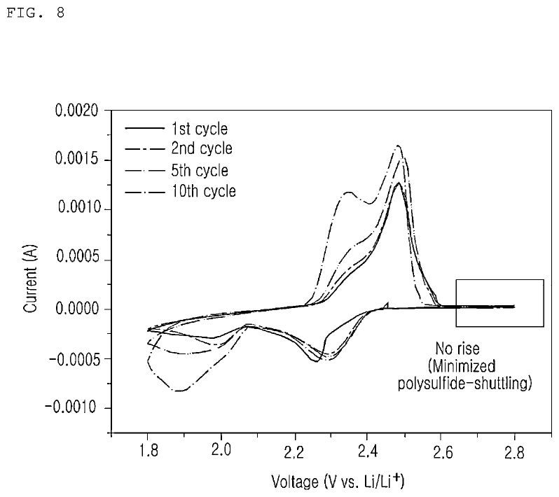

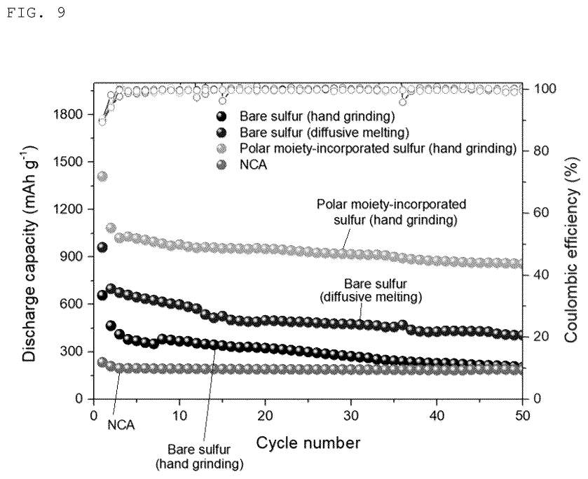

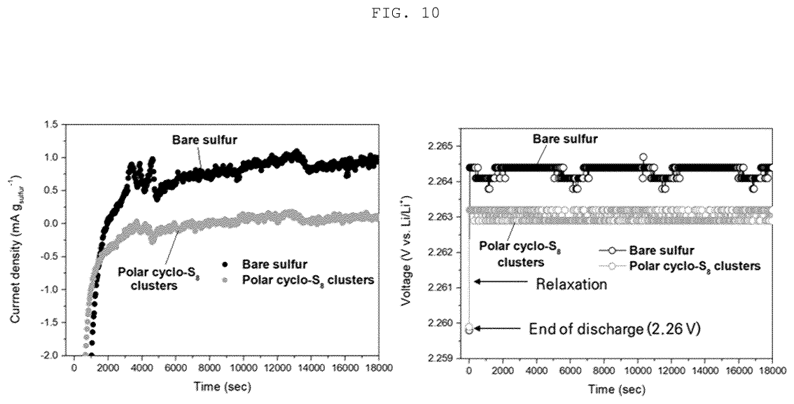

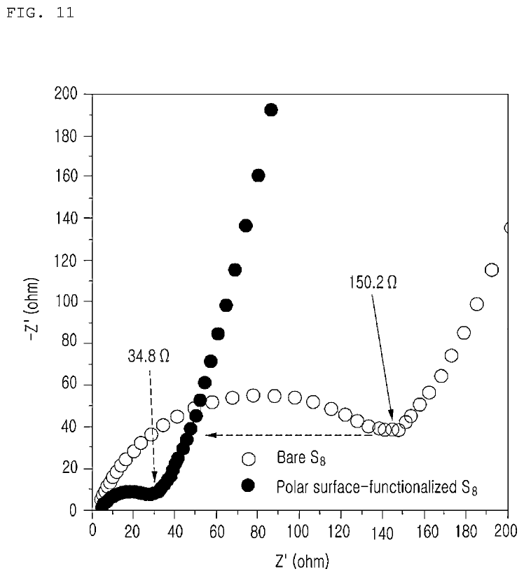

FIG. 7 shows charge and discharge voltage profiles of half-cells to which the electrode of the comparative example and the electrode of the present example 1 are applied, respectively, FIG. 8 shows cyclic voltammetry measurement results of the half-cell to which the electrode of the present example 1 is applied, FIG. 9 shows charge and discharge cycle performance measurement results of the half-cell to which the electrode of the present example 1 is applied, FIG. 10 shows shuttle current analysis results of the half-cell to which the electrode of the present example 1 is applied, and FIG. 11 shows electrochemical impedance measurement results of the half-cell to which the electrode of the present example 1 is applied. In this case, a mixed solution of dimethoxyethane and 1,3-dioxolane (1:1 v/V %), in which 1M LiTFSI and 2 wt % nitric acid lithium (LiNO₃) are dissolved, was used as the electrolyte of the half-cell.

Referring to FIGS. 7 to 11, while the half-cell with the electrode according to the comparative example showed a poor initial capacity realization rate of about 40%, the half-cell with the electrode according to the present example 1 showed an excellent initial capacity realization rate of about 85% or more. In addition, in the case of the electrode with the polar sulfur powder prepared according to the present example 1, the voltage of the second flat potential section in the galvanostatic charge and discharge profile was found to be considerably lowered compared to that of the electrode with the bare sulfur powder. This indirectly shows that the formation of soluble lithium-polysulfide is effectively suppressed by a catalytic effect or the like, and the lithiation reaction of the quasi-solid phase based on the solid-phase conversion reaction is in progress in the electrode with polar sulfur powder prepared according to the present example 1.

In the case where there is no host material, the bare sulfur exhibited a low capacity realization rate of about 20% of its theoretical capacity under high loading conditions (about 6 mg/cm²), but the sulfur powder prepared according to the present example 1 exhibited an excellent capacity realization rate of 85% or more of its theoretical capacity even under high loading conditions (about 6 mg/cm²), like that under low loading conditions.

After 50 cycles of operation at a current density of 500 mA/g, while the electrode according to the comparative example with the bare sulfur having no host material showed a poor capacity retention rate of less than 60%, the electrode according to the present example 1 showed a capacity retention rate of over 85%, comparable to the NCA positive electrode material. For reference, commercial NCA has a capacity retention rate of about 93%. This is because quasi-solid-phase (semi-solid-phase) lithiation behavior occurs in the electrode according to the present example 1, judging from the lowered flat potential of the voltage profile and the reduced formation reaction of the long-chain polysulfide.

With comparison in shuttle current analysis results between the electrode according to the comparative example and the electrode according to the present example 1, while the electrode according to the comparative example exhibited a shuttle current density of 0.99 mA/g sulfur, the electrode according to the present example 1 exhibited a shuttle current density of 0.08 mA/g sulfur. Thus, it will be understood that the organic molecules bound to the surface of the electrode according to the present example 1 suppresses the elution of long-chain polysulfides during the lithiation of sulfur.

In the sulfur material having the functionalized surface according to the disclosure, the preparation method thereof, the electrode for the metal-sulfur secondary battery including the same and the metal-sulfur secondary battery including the sulfur material, the interior of the sulfur material includes the cyclic molecules of sulfur, such as cyclo-S₈, having an orthorhombic crystal structure, and the surface includes the linear multiple sulfur material with about 2 to 7 sulfur atoms to form a closed ring-shaped chemical bond with the first and second carbon atoms derived from the vinyl group of the organic molecular material, so that the surface can be functionalized by the organic molecule, thereby making it possible to introduce an aqueous electrode manufacturing process when applied to the secondary battery, and thus produce uniform aqueous dispersion sulfur and manufacture an aqueous binder-based positive electrode. Further, the positive electrode manufactured using such sulfur particles is significantly improved in an actual capacity realization rate of sulfur compared to theorical capacity during charge and discharge, and significantly reduces the formation of soluble lithium-polysulfides.

In addition, the organic molecular material may include the polar functional group, so that the sulfur powder can be significantly improved in dispersibility in the polar solvent such as water.

Although a few embodiments of the disclosure have been described, it will be understood that various modifications and changes can be made by those skilled in the art without departing from the spirit and scope of the disclosure defined in the appended claims.

1. A sulfur material comprising:
a sulfur powder; and
an organic molecular material chemically bonded to a surface of the sulfur powder.

2. The sulfur material of claim 1, wherein
an interior of the sulfur powder has a crystalline structure with cyclic molecules of sulfur,
the surface of the sulfur powder comprises a linear multiple sulfur material with about 2 to 7 sulfur atoms, and
the organic molecular material is chemically bonded to the sulfur atoms located at an end of the linear multiple sulfur material.

3. The sulfur material of claim 2, wherein the organic molecular material comprises first and second carbon atoms derived from a vinyl group and chemically bonded directly to the sulfur atoms located both ends of the linear multiple sulfur material, respectively.

4. The sulfur material of claim 3, wherein the first and second carbon atoms and the sulfur atoms of the linear multiple sulfur material form a chemical bond in a form of a closed ring.

5. The sulfur material of claim 4, wherein the organic molecular material comprises a polar functional group.

6. The sulfur material of claim 5, wherein the polar functional group comprises one or more selected from a group consisting of a hydroxyl group(—OH), a carboxyl group(—COOH), an amine group(—NH₂) and a sulfonic acid group(—SO₃H).

7. The sulfur material of claim 3, wherein the organic molecular material is derived from one or more selected from a group consisting of the following chemical formulae 1 to 13: 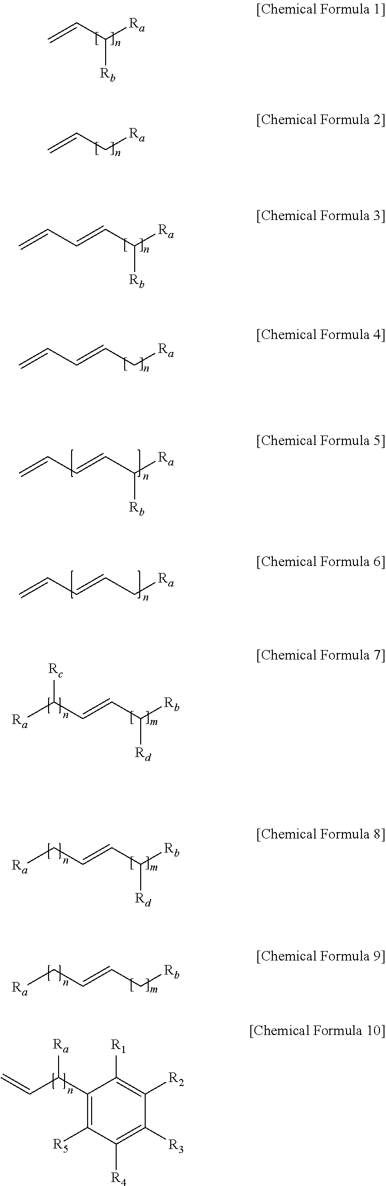 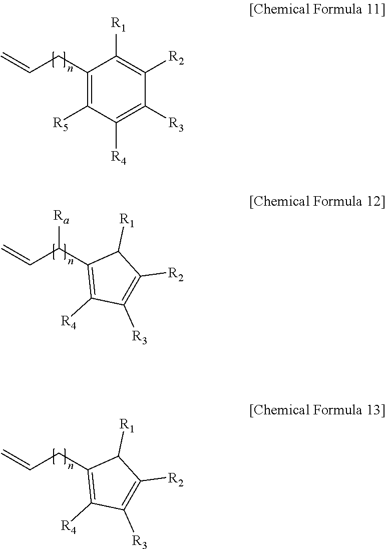
where, Rₐ, R_{b}, R_{c}, Rₐ, R₁, R₂, R₃, R₄, R₅ and R₆ in each of the chemical formulae 1 to 13 are selected from a group consisting of hydrogen (H), a hydroxyl group (—OH), a carboxyl group (—COOH), an amine group (—NH₂), a sulfonic acid group (—SO₃H), and an aryl group (aryl) independently of each other, and n and m are integers of 0 to 100 independently of each other.

8. A method of preparing a sulfur material, the method comprising:
first step of preparing a crystalline colloid of sulfur powder that contains cyclic molecules of sulfur;
second step of forming first linear multiple sulfur ions by adding an alkali metal-containing basic solution to the colloid to ring-open the cyclic molecules of sulfur located on a surface of the sulfur powder; and
third step of decomposing at least some of the first linear multiple sulfur ions into second linear multiple sulfur ions by adding an organic molecule having a vinyl group and an electron transfer-based oxidizing agent to the colloid, and forming a chemical bond by reacting the vinyl group of the organic molecule with the second linear multiple sulfur ions.

9. The method of claim 8, wherein
the alkali metal-containing basic solution comprises a basic solution that contains lithium (Li) ions, sodium (Na) ions, or potassium (K) ions, and
the cyclic molecules of sulfur located on the surface of the sulfur powder is ring-opened to form linear multiple sulfur ions during the second step.

10. The method of claim 9, wherein the alkali metal-containing basic solution comprises a lithium hydroxide (LiOH) aqueous solution, a sodium hydroxide (NaOH) aqueous solution, or a potassium hydroxide (KOH) aqueous solution.

11. The method of claim 8, wherein chemical bonds are formed between sulfur atoms located at both ends of the second linear multiple sulfur ions and binding sites formed in first and second carbon atoms in the vinyl group activated by the electron transfer-based oxidizing agent during the third step.

12. The method of claim 8, wherein the organic molecule further comprises a polar functional group in addition to the vinyl group.

13. The method of claim 12, wherein the polar functional group comprises one or more selected from a group consisting of a hydroxyl group (—OH), a carboxyl group (—COOH), an amine group (—NH₂) and a sulfonic acid group(—SO₃H).

14. The method of claim 8, wherein the organic molecule comprises one or more selected from a group consisting of the following chemical formulae 1 to 13: 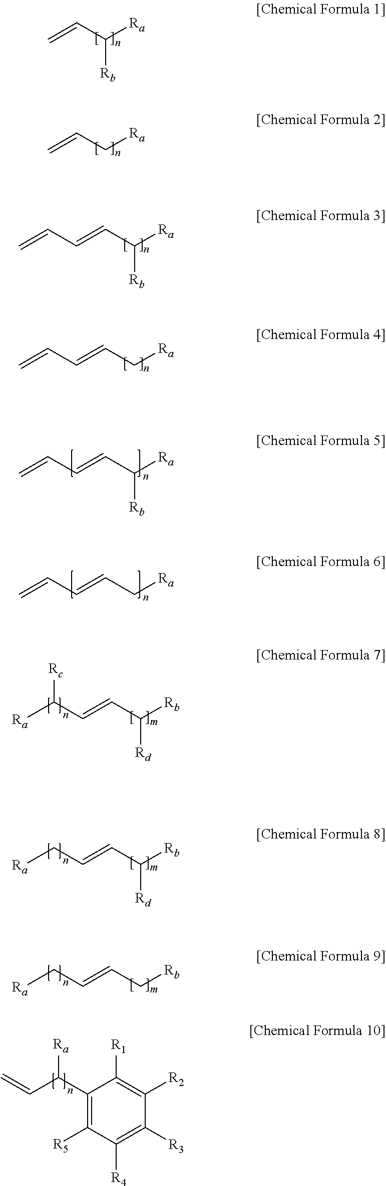 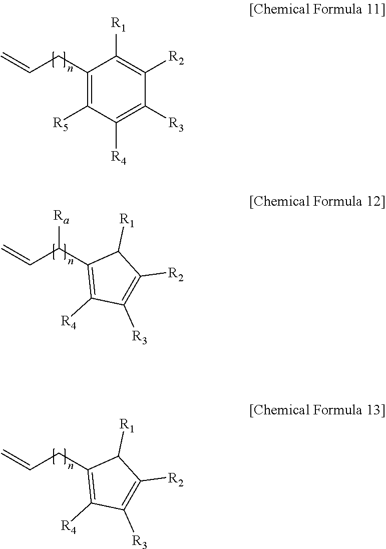
where, Rₐ, R_{b}, R_{c}, R_{d}, R₁, R₂, R₃, R₄, R₅ and R₆ in each of the chemical formulae 1 to 13 are selected from a group consisting of hydrogen (H), a hydroxyl group (—OH), a carboxyl group (—COOH), an amine group (—NH₂), a sulfonic acid group (—SO₃H), and an aryl group (aryl) independently of each other, and n and m are integers of 0 to 100 independently of each other.

15. The method of claim 8, wherein the organic molecule is added to the colloid at a molar ratio of 10:1 to 1:10 relative to sulfur in the colloid.

16. The method of claim 15, wherein the electron transfer-based oxidizing agent comprises a persulfate compound, a permanganate compound, a perchlorate compound, or a perborate compound.

17. The method of claim 8, wherein a hydrogen ion donating compound is further added during the third step.

18. The method of claim 17, wherein the hydrogen ion donating compound comprises one or more inorganic acids selected from a group consisting of hydrochloric acid (HCl), sulfuric acid (H₂SO₄), nitric acid (HNO₃), and hydrogen peroxide (H₂O₂), or organic acid having a carboxyl group (—COOH), a hydroxyl group (—OH), or a sulfonic acid group (—SO₃H).

19. An electrode for a metal-sulfur secondary battery, comprising an active material layer that comprises a sulfur material, a conductive material, and a binder,
wherein the sulfur material comprises the sulfur material of claim 1.

20. A metal-sulfur secondary battery comprising:
a positive electrode;
a negative electrode disposed to face the positive electrode, and comprising lithium; and
an electrolyte disposed between the positive electrode and the negative electrode,
wherein the positive electrode comprises the sulfur material of claim 1.
